(19) United States
(12) Patent Application Publication
(10) Pub. No.: US 2026/0194925 A1
(43) Pub. Date: Jul. 9, 2026

(54) METHODS, SYSTEMS, AND MEDIA FOR SMART GAS FLOW MONITORING BASED ON INTERNET OF THINGS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei HE, Chengdu (CN); Yunsong GU, Chengdu (CN)

(73) Assignee: CHENGDU QINCHUAN IOT TECHNOLOGY CO., LTD., Chengdu (CN)

(21) Appl. No.: 19/559,909

(22) Filed: Mar. 6, 2026

(30) Foreign Application Priority Data
Jan. 20, 2026 (CN) 202610069843.X

(51) Int. Cl. G16Y 40/10; G05D 7/06; G06Q 50/06

(52) U.S. Cl. CPC G05D 7/0635; G06Q 50/06; G16Y 40/10

(57) ABSTRACT

A method for an smart gas flow monitoring based on IoT is provided. The method includes: generating gas transmission information with a time label based on sensor data uploaded by a pipeline sensor and historical sampling data uploaded by at least one of a gas gate station or a pressure regulating station; obtaining gas volumetric flows collected by a gas metering device deployed on a gas transmission pipeline at a plurality of time points within a current period; generating standard gas flows of the gas transmission pipeline at the plurality of time points based on the gas volumetric flows; generating a cumulative gas flow of the gas transmission pipeline within the current period based on the standard gas flows; and controlling at least one of an opening/closing state or an opening degree of a regulating valve of the gas transmission pipeline based on the cumulative gas flow.

### CROSS-REFERENCE TO RELATED APPLICATIONS

This application claims priority to the Chinese Patent Application No. 202610069843.X, filed on Jan. 20, 2026, the contents of which are hereby incorporated by reference.

### TECHNICAL FIELD

The present disclosure generally relates to the field of gas monitoring, and in particular to a method, a system, and a medium for smart gas flow monitoring based on Internet of Things (IoT).

### BACKGROUND

With the acceleration of urbanization and the increasing demand for clean energy, gas, as a clean and efficient energy source, is being used more widely in daily life and industrial production. However, the accuracy of gas metering directly affects economic benefits of gas supply companies and the user experience. Traditional gas metering manners are mainly based on volumetric flow measurement, but these manners often fail to provide accurate metering results when facing gas pressure fluctuations, gas composition variations, or impurity content differences. Especially in complex environments, factors such as differences in pipeline inner diameters and the influence of pipeline deposits may cause data distortion in traditional metering manners.

The present disclosure aims to provide a method for smart gas flow monitoring based on IoT (IoT). By combining information obtained from sensors configured on gas transmission pipelines and utilizing big data analysis manners and machine learning models to dynamically adjust metering parameters, the method not only improves the accuracy of gas metering but also provides strong support for smart city construction and energy management.

### SUMMARY

One or more embodiments of the present disclosure provide a method for smart gas flow monitoring based on IoT (IoT). The method is executed by a gas company management platform. The method includes: generating gas transmission information with a time label based on sensor data uploaded by a pipeline sensor and historical sampling data uploaded by at least one of a gas gate station or a pressure regulating station, and storing the gas transmission information in the one or more company servers; obtaining gas volumetric flows collected by a gas metering device deployed on a gas transmission pipeline at a plurality of time points within a current period; generating standard gas flows of the gas transmission pipeline at the plurality of time points within the current period through data preprocessing based on the gas volumetric flows; generating a cumulative gas flow of the gas transmission pipeline within the current period based on the standard gas flows; and controlling at least one of an opening/closing state or an opening degree of a regulating valve of the gas transmission pipeline based on the cumulative gas flow, to determine a gas flow entering a gas generation device.

One or more embodiments of the present disclosure provide an IoT (IoT) system for smart gas flow monitoring. The system includes a gas user platform, a gas service platform, a gas company management platform, a gas company sensor network platform, and a gas equipment object platform. The gas company management platform is configured on one or more company servers. The gas company management platform is configured to execute the method for smart gas flow monitoring based on IoT.

One or more embodiments of the present disclosure provide a non-transitory computer-readable storage medium. The storage medium stores computer instructions. When a computer reads the computer instructions in the storage medium, the computer executes a method for smart gas flow monitoring based on IoT.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbering indicates the same structure, wherein:

FIG. 1 is a schematic diagram of a platform structure of an IoT system for smart gas flow monitoring according to some embodiments of the present disclosure;

FIG. 2 is a flowchart of an exemplary process for smart gas flow monitoring based on IoT according to some embodiments of the present disclosure;

FIG. 3 is a flowchart of an exemplary process for generating standard gas flows at a plurality of sampling time points according to some embodiments of the present disclosure;

FIG. 4 is a flowchart of another exemplary process for generating standard gas flows at a plurality of sampling time points according to some embodiments of the present disclosure;

FIG. 5 is a schematic diagram of an exemplary transformation model according to some embodiments of the present disclosure; and

FIG. 6 is an exemplary schematic diagram for determining a faulty device according to some embodiments of the present disclosure.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

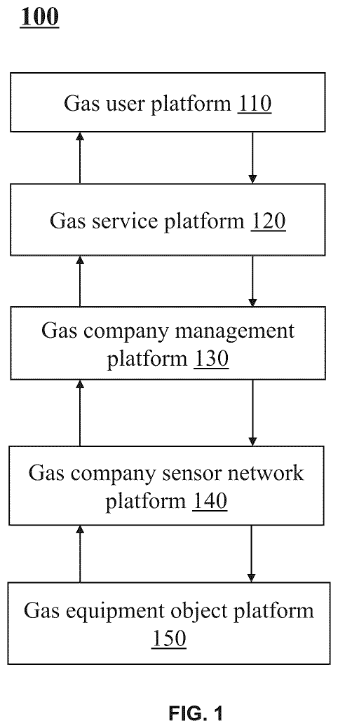

FIG. 1 is a schematic diagram of a platform structure of an IoT system for smart gas flow monitoring according to some embodiments of the present disclosure.

In some embodiments, as shown in FIG. 1, an IoT system 100 for smart gas flow monitoring may include a gas company management platform 130, a gas company sensor network platform 140, a gas equipment object platform 150, a gas service platform 120, and a gas user platform 110.

In some embodiments, all platforms in the IoT system 100 for smart gas flow monitoring mentioned above may implement data interaction with each other. Merely by way of example, the gas company sensor network platform 140 may obtain gas volumetric flows collected by the gas equipment object platform 150 at a plurality of time points within a current period, and sends the collected gas volumetric flows to the gas company management platform 130.

The gas company management platform 130 refers to a comprehensive platform that coordinates and manages connections and collaborations among various functional platforms of a gas company, aggregates all information of the IoT, analyzes and processes data and/or information generated during the operation of the gas company, and generates and executes instructions. In some embodiments, the gas company management platform 130 is configured on one or more company servers. The company server includes a memory and a processor.

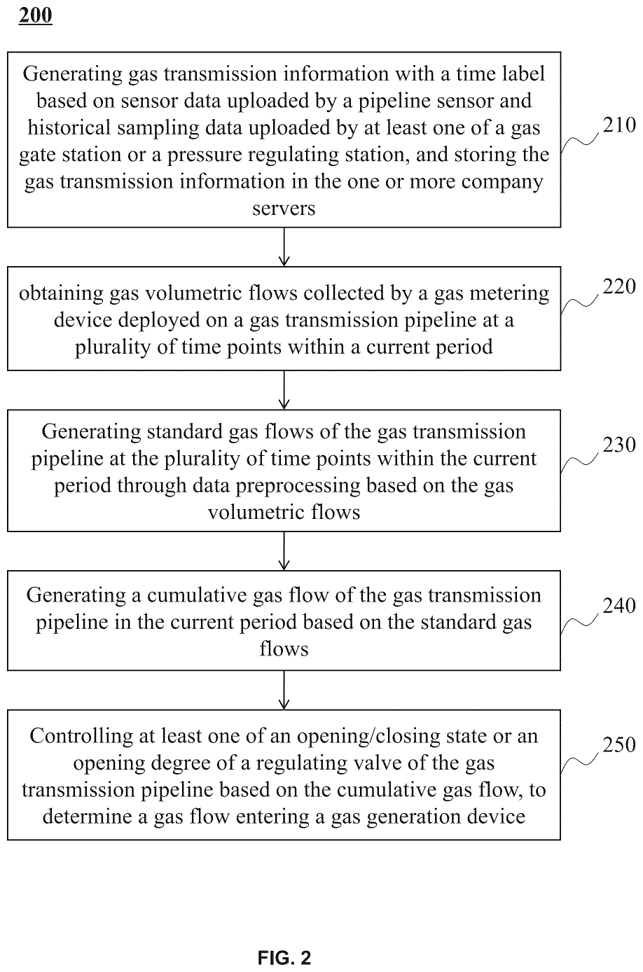

In some embodiments, the gas company management platform 130 may be configured to determine a gas flow entering a gas generation device based on sensor data uploaded by a pipeline sensor and historical sampling data uploaded by at least one of a gas gate station or a pressure regulating station. More descriptions regarding this part may be found in FIG. 2 and related descriptions thereof.

The gas company sensor network platform 140 refers to a comprehensive management platform for sensor information of the gas company. In some embodiments, the gas company sensor network platform 140 may be configured as communication equipment and/or a gateway, etc. For example, the gas company sensor network platform 140 may be configured as a communication network and a gateway to implement functions such as data management and data transmission.

The gas equipment object platform 150 refers to a functional platform for real-time monitoring and smart regulation of a gas pipeline network. In some embodiments, the gas equipment object platform 150 includes at least various pipeline sensors deployed in the gas pipeline network, a gas gate station and/or a pressure regulating station, a gas metering device, and a gas regulation device. More descriptions regarding the gas metering device may be found in FIG. 2 and related descriptions thereof.

The gas regulation device refers to related equipment for controlling and regulating a gas flow state in the gas pipeline network. In some embodiments, the gas regulation device may include a regulating valve of a gas transmission pipeline.

The gas service platform 120 refers to a platform for conveying user requirements and control information. In some embodiments, the gas service platform 120 may be configured as a processor and/or a server, etc.

The gas user platform 110 refers to a platform for interacting with users. In some embodiments, the gas user platform 110 may be configured as a terminal device and/or a server. The terminal device may include a terminal device of a user, e.g., a smartphone, a tablet computer, etc.

More descriptions regarding the various platforms mentioned above may be found in FIG. 2 to FIG. 4 and related descriptions thereof.

In some embodiments of the present disclosure, based on the IoT system 100 for smart gas flow monitoring, an information operation closed loop may be formed among various functional platforms. The information operation closed loop operates in a coordinated and regular manner under the unified management of the gas company management platform, thereby achieving informatization and intelligence in monitoring and managing the gas flow state in gas pipelines.

FIG. 2 is a flowchart of an exemplary process for smart gas flow monitoring based on IoT according to some embodiments of the present disclosure. As shown in FIG. 2, a process 200 includes the following operations. In some embodiments, the process 200 may be executed by the gas company management platform in the IoT system for smart gas flow monitoring. Merely by way of example, the process 200 may be executed by a processor in a company server where the gas company management platform is located.

In 210, gas transmission information with a time label is generated based on sensor data uploaded by a pipeline sensor and historical sampling data uploaded by at least one of a gas gate station or a pressure regulating station, and the gas transmission information is stored in the one or more company servers.

The pipeline sensors may include a pressure sensor, a temperature sensor, etc., deployed inside the gas transmission pipeline. The pipeline sensors are configured to obtain sensor data of gas transmitted inside the pipeline, e.g., gas pressure, gas temperature, or the like.

The gas gate station refers to a receiving station where gas enters an urban pipeline network from a long-distance transmission pipeline. In some embodiments, the gas gate station may be configured with hardware facilities such as a filter, a separator, a sampling device, a gas analyzer, or the like.

The pressure regulating station refers to a facility node that regulates gas pressure inside a pipeline during gas transmission in a gas pipeline. In some embodiments, the pressure regulating station may be configured with hardware facilities such as a pressure reducing valve, a pressure regulator, or the like.

The historical sampling data refers to gas-related data obtained by analyzing components, impurity content, or the like, of collected gas at key nodes such as the gas gate station and/or the pressure regulating station within a current period and a past period of time. The historical sampling data may be obtained based on analysis of collected gas samples by analysis devices such as the gas analyzer configured in the gas gate station and/or the pressure regulating station.

The gas transmission information refers to gas physical state data collected and recorded based on time variation during the gas transmission. In some embodiments, the gas transmission information includes gas transmission pressure, gas component data, gas impurity content, and time labels corresponding to these data (i.e., the gas transmission pressure, the gas component data, and the gas impurity content). The time label is configured to record a specific time when the data in the gas transmission information is collected.

In 220, gas volumetric flows collected by a gas metering device deployed on a gas transmission pipeline at a plurality of time points within a current period are obtained.

The gas metering device refers to a related device configured to collect and record the gas volumetric flow in the gas pipeline. In some embodiments, the gas metering device may include an ultrasonic flow meter, a turbine flow meter, or the like, deployed on the gas pipeline.

The current period refers to the time period to which the current moment belongs. In some embodiments, a length and time points of the current period may be preset manually. For example, a period from the current moment to nine days before the current moment is the current period, with a time point set every three days.

The gas volumetric flow refers to a volume of gas passing through a cross-section of the transmission pipeline per unit time. In some embodiments, the gas volumetric flow may be collected based on the gas metering device.

In some embodiments, the gas volumetric flows at the plurality of time points collected by the gas metering device may be uploaded to the gas equipment object platform via a network. The gas equipment object platform may summarize the gas volumetric flows and upload the gas volumetric flows to the gas company management platform.

In 230, standard gas flows of the gas transmission pipeline at the plurality of time points within the current period are generated through data preprocessing based on the gas volumetric flows.

In some embodiments, the data preprocessing may include data format conversion, data value transformation, data screening, or the like.

The standard gas flow refers to a volumetric flow of gas passing through the cross-section of the transmission pipeline per unit time under standard conditions.

In some embodiments, the gas company management platform may obtain the standard gas flows based on the gas volumetric flows. Merely by way of example, the gas company management platform may query a first preset table based on the gas volumetric flows and gas pressure and gas temperature monitored when the gas volumetric flows are obtained, to obtain the standard gas flows. The first preset table refers to a table including a one-to-one correspondence relationship between a plurality of sets of [gas pressure, gas temperature, gas volumetric flow] and the standard gas flow. In some embodiments, the first preset table may be constructed based on a gas volume measured under standard conditions (e.g., standard atmospheric pressure, 25° C.) (i.e., the standard gas flow) for gases of different masses, and gas volume measured under different gas pressure and gas temperature conditions (i.e., the gas volumetric flow) for the gases of different masses.

In some embodiments, the gas company management platform may further configured to: obtain upstream and downstream difference information of the gas transmission pipeline within the current period based on the gas equipment object platform; generate a gas characteristic variation of the gas transmission pipeline within the current period based on the gas transmission information at a plurality of sampling time points within the current period; generate the standard gas flows at the plurality of sampling time points based on the upstream and downstream difference information and the gas characteristic variation of the current period, and the gas volumetric flows at the plurality of sampling time points; determine the standard gas flows at the plurality of time points based on the standard gas flows at the plurality of sampling time points; and adjust a sampling time point interval of the gas transmission pipeline based on the standard gas flows at the plurality of sampling time points.

The upstream and downstream difference information refers to information reflecting a difference between an upstream gas pipeline and an adjacent downstream gas pipeline. In some embodiments, the upstream and downstream difference information may include a thickness difference of pipeline attachments and an inner diameter size difference between the upstream gas pipeline and its adjacent downstream gas pipeline.

In some embodiments, the gas company management platform may obtain a thickness of pipeline attachments for each pipeline section from record data of pipeline inspections during regular maintenance of gas pipelines by the gas company, to calculate the thickness difference of the pipeline attachments. In some embodiments, the gas company management platform may obtain an inner diameter of each gas pipeline from pipeline specification data uploaded during pipeline installation, to calculate the inner diameter size difference of the pipeline.

The sampling time point refers to a specific time point set to obtain the gas transmission information during the gas transmission. An interval between adjacent sampling time points is less than an interval between adjacent time points. There are a plurality of sampling time points between two adjacent time points.

The gas characteristic variation refers to variation data of various characteristic indicators in gas transmission information at different sampling time points. The gas characteristic variation may be represented by a vector sequence composed of gas transmission pressure variation, gas component variation, and gas impurity content variation corresponding to each group of adjacent sampling time points within a plurality of sampling time point intervals.

In some embodiments, the gas company management platform may obtain standard gas flows at a plurality of sampling time points based on gas volumetric flows at the plurality of sampling time points. More descriptions regarding determining the standard gas flow based on the gas volumetric flow may be found in the foregoing content.

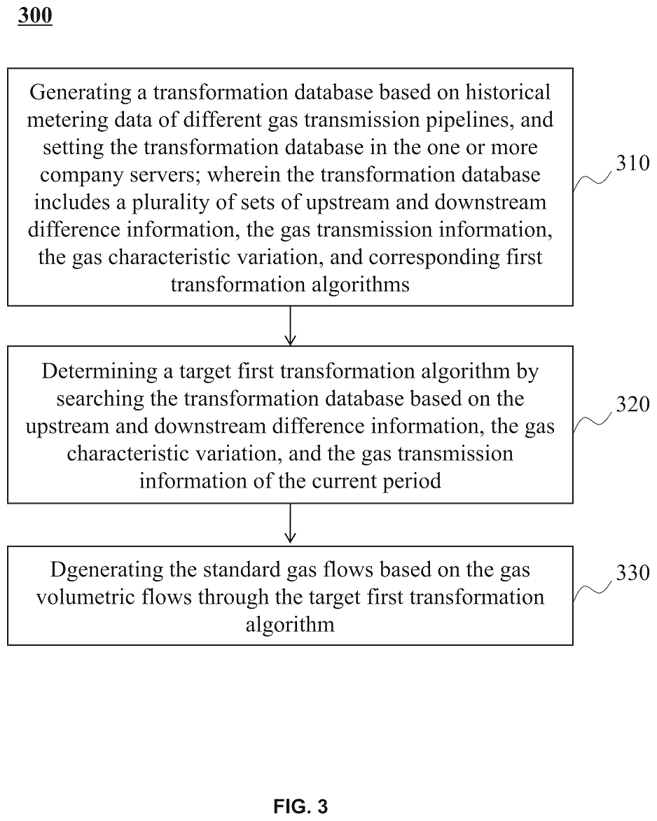

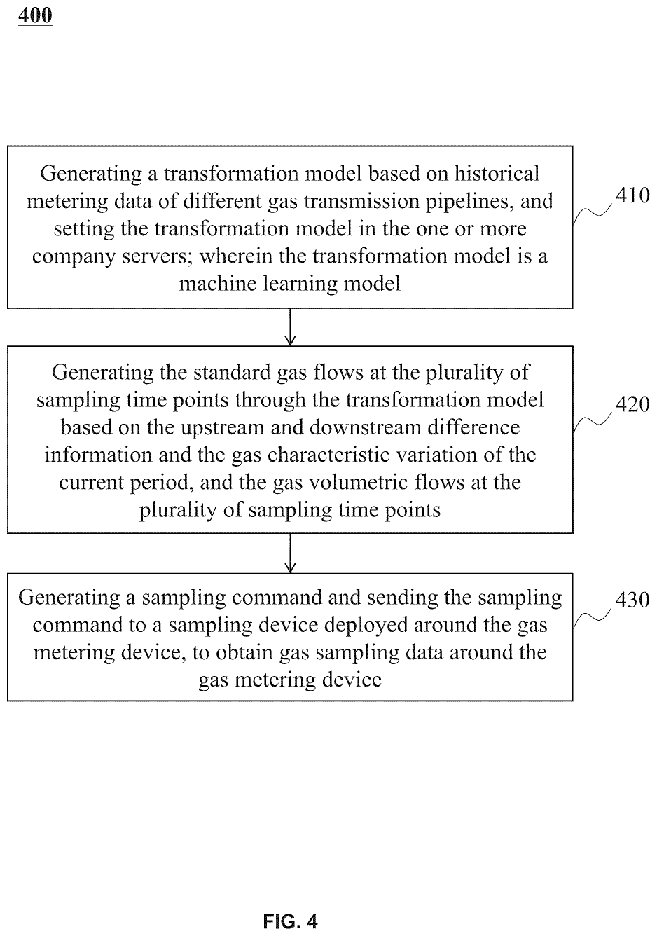

In some embodiments, a processor may determine the standard gas flow based on historical metering data of different gas transmission pipelines. More descriptions regarding this part may be found in FIG. 3 and FIG. 4 and related descriptions thereof.

In some embodiments, the gas company management platform may determine a standard gas flow of a latter time point of two adjacent time points based on standard gas flows at a plurality of sampling time points between the two adjacent time points by means such as averaging.

The sampling time point interval refers to a time interval between adjacent sampling time points. In some embodiments, the gas company management platform may adjust the sampling time point interval based on a change rate of the standard gas flow corresponding to adjacent sampling time points. Merely by way of example, the adjustment may be performed according to: adjusted sampling time point interval=sampling time point interval before adjustment*(1−change rate of the standard gas flow). The change rate of the standard gas flow=|standard gas flow at sampling time point 1−standard gas flow at sampling time point 2|/standard gas flow at sampling time point 1.

In some embodiments of the present disclosure, the gas company management platform may dynamically adjust related parameters of data preprocessing involved in a process of generating the standard gas flow based on the gas volumetric flow by considering the gas characteristic variation at the plurality of sampling time points, thereby ensuring reliability of gas flow metering and applicability in complex environments. The gas company management platform further dynamically adjusts the sampling time point interval according to a change situation of the standard gas flow, which can improve effectiveness of sampling data.

In 240, a cumulative gas flow of the gas transmission pipeline within the current period is generated based on the standard gas flows.

The cumulative gas flow refers to a cumulative total volumetric flow of gas flowing through a cross-section of a pipeline within a time period.

In some embodiments, the gas company management platform may obtain the cumulative gas flow through interpolation calculation based on the standard gas flows corresponding to a plurality of adjacent time points within the current period. Merely by way of example, a time length of the current period is 24 h, and the current period includes time point 1 and time point 2. During the gas transmission, at time point 1, the standard gas flow is 2 m³/h; at time point 2, the standard gas flow is 3 m³/h. Then, the cumulative gas flow within the current period of 24 hours may be calculated as follows: cumulative gas flow=(2 m³/h+3 m³/h)/2×24 h=60 m³.

In 250, at least one of an opening/closing state or an opening degree of a regulating valve of the gas transmission pipeline is controlled based on the cumulative gas flow, so as to determine a gas flow entering a gas generation device.

In some embodiments, the gas company management platform may determine an opening degree of the regulating valve based on the cumulative gas flow, a historical cumulative flow, and a preset flow threshold when a sum of the historical cumulative flow and the current cumulative gas flow is about to reach the preset flow threshold. The gas company management platform may generate a regulation instruction based on the opening degree of the regulating valve and send the regulation instruction to the gas equipment object platform to instruct the gas equipment object platform to control the opening/closing state and/or the opening degree of the regulating valve according to the opening degree of the regulating valve.

The historical cumulative flow is a total volumetric flow of gas consumed by a gas user before the current period. The preset flow threshold refers to a preset usage upper limit value of gas volumetric flow. The preset flow threshold may be obtained through manual preset or determined according to a prepaid fee of the gas user. Merely by way of example, the gas company management platform may determine the opening degree of the regulating valve based on the following formula:

$$p = 1 - ( {m}_{1} + {m}_{h} - {m}_{0} \times j ) ,$$

where p is the opening degree of the regulating valve, m₁ is the cumulative gas flow, mₕ is the historical cumulative flow, m₀ is the preset flow threshold, and j is a threshold fraction. A value of j is between 0 and 1, and the value of j may be obtained through manual preset.

The gas generation device refers to a device or system that maintains an operating state by consuming gas. In some embodiments, the gas generation device may include a gas cooking appliance, a gas turbine, or the like.

A gas flow refers to an amount of gas passing through a pipeline per unit time. The gas flow may be represented by a gas volumetric flow (e.g., cubic meters per hour, m³/h) or a standard gas flow (e.g., normal cubic meters, Nm³). More descriptions regarding the gas volumetric flow, the standard gas flow, and acquisition manners of the gas volumetric flow and the standard gas flow may be found in the foregoing content.

In some embodiments of the present disclosure, when gas pressure, gas components, or impurity content (affecting gas density, calorific value, etc.) change or fluctuate frequently, the gas company management platform may ensure applicability and accuracy of the gas metering device by performing reasonable transformation on data collected by gas metering and setting reasonable metering parameters. The gas company management platform enables the system platform to meet gas flow monitoring under complex environments and complex fluid regulation, thereby ensuring accuracy of the system platform for gas metering and billing in the gas pipeline network. Furthermore, the gas company management platform may appropriately reduce the opening degree of the regulating valve corresponding to a gas user under reasonable premises (e.g., about to exceed a fee) to avoid greater billing losses or to avoid affecting the gas usage of the gas user.

FIG. 3 is a flowchart of an exemplary process for generating standard gas flows at a plurality of sampling time points according to some embodiments of the present disclosure. As shown in FIG. 3, process 300 includes the following operations. In some embodiments, process 300 may be executed by the gas company management platform in the IoT system for smart gas flow monitoring. For example, process 300 may be executed by a processor in the company server where the gas company management platform is located.

In 310, a transformation database is generated based on historical metering data of different gas transmission pipelines, and the transformation database is set in the one or more company servers; the transformation database includes a plurality of sets of upstream and downstream difference information, gas transmission information, and gas characteristic variation, and a plurality of corresponding first transformation algorithms.

The historical metering data refers to historically recorded information related to gas flow. The gas flow includes gas volumetric flow and standard gas flow.

In some embodiments, the historical metering data may be obtained from a database of the gas company management platform.

The transformation database refers to a related database for gas metering. In some embodiments, the transformation database is constructed based on a large amount of historical gas transmission data.

In some embodiments, the transformation database includes the plurality of sets of upstream and downstream difference information, gas transmission information, and gas characteristic variation, and the plurality of corresponding first transformation algorithms. Related content regarding the upstream and downstream difference information, the gas transmission information, and the gas characteristic variation may be found in FIG. 2 and related descriptions thereof.

The first transformation algorithm refers to a related algorithm for gas metering. Independent variables in the first transformation algorithm may be gas volumetric flow corresponding to the upstream and downstream difference information, the gas transmission information, the gas characteristic variation, and the standard gas flow; dependent variables in the first transformation algorithm may be a combination of corresponding weight coefficients. In some embodiments, the gas company management platform may determine the first transformation algorithm in a variety of ways.

In some embodiments, the gas company management platform utilizes a processor in the company server. In some embodiments, the processor may determine parameters in each first transformation algorithm using a fitting manner based on gas volumetric flows corresponding to a plurality of identical or similar (e.g., a difference not greater than 5%) upstream and downstream difference information, gas transmission information, and gas characteristic variation in the historical gas transmission data, and standard gas flows obtained based on sampling devices.

In some embodiments, for a set of identical or similar upstream and downstream difference information, gas transmission information, and gas characteristic variation, the standard gas flow may be determined by calculation using formula (1).

$$standard gas flow = ( a \times m 1 + b \times m 2 + c \times m 3 ) \times gas volumetric flow , \qquad ( 1 )$$

a, b, and c are weight coefficients; m1, m2, and m3 are the upstream and downstream difference information, the gas transmission information, and the gas characteristic variation after normalization or standardization processing, respectively.

In some embodiments, manners for normalization or standardization processing may include Z-score standardization, Min-Max standardization, or the like.

Formula (1) may be considered as the first transformation algorithm corresponding to the set of identical or similar upstream and downstream difference information, gas transmission information, and gas characteristic variation. In some embodiments, different first transformation algorithms have different corresponding weight coefficients.

In some embodiments, for each first transformation algorithm, the gas company management platform may determine weight coefficients involved in the first transformation algorithm based on the fitting manner according to a set of identical or similar historical metering data.

In some embodiments, using the above manner, a large number of first transformation algorithms are generated, and the transformation database is constructed through the historical metering data and the corresponding plurality of upstream and downstream difference information, gas transmission information, and gas characteristic variation of the historical metering data.

It should be understood that formula (1) is merely an exemplary implementation of the first transformation algorithm. In other embodiments, the first transformation algorithm may also be other mathematical models trained based on historical data, such as a multivariate nonlinear regression model, a support vector machine model, etc., which are not limited in the present disclosure.

In 320, a target first transformation algorithm is determined by searching the transformation database based on the upstream and downstream difference information, the gas characteristic variation, and the gas transmission information of the current period.

The target first transformation algorithm refers to a most matching first transformation algorithm selected by comprehensively considering the upstream and downstream difference information, the gas transmission information, and the gas characteristic variation of the current period. For example, the target first transformation algorithm is the first transformation algorithm corresponding to the upstream and downstream difference information, the gas characteristic variation, and the gas transmission information of the current period in the transformation database.

In 330, the standard gas flows are generated based on the gas volumetric flows through the target first transformation algorithm.

In some embodiments, the gas company management platform may substitute the gas volumetric flow and the upstream and downstream difference information, the gas transmission information, and the gas characteristic variation of the current period into the target first transformation algorithm to obtain the standard gas flow.

It is known that there are two situations: the upstream and downstream difference information and the gas characteristic variation satisfying a preset stable condition, and the upstream and downstream difference information and the gas characteristic variation not satisfying the preset stable condition. In some embodiments, in response to the upstream and downstream difference information and the gas characteristic variation satisfying the preset stable condition, generate the standard gas flow through the target first transformation algorithm based on the gas volumetric flow.

The preset stable condition refers to a difference in the upstream and downstream difference information and the gas characteristic variation being less than a second difference threshold. The difference in the upstream and downstream difference information and the gas characteristic variation refers to a discrepancy value between two data. For example, the difference may be a discrepancy value between two data in the upstream and downstream difference information, or a discrepancy value between two data in the gas characteristic variation.

In some embodiments, the preset stable condition may be set by default by a processor or preset by a technician based on experience.

In some embodiments of the present disclosure, the preset stable condition is limited by the upstream and downstream difference information and the gas characteristic variation, thereby ensuring an accuracy level of generating the standard gas flow from the gas volumetric flow through the first transformation algorithm.

In some embodiments of the present disclosure, the transformation database is generated through historical metering data of different gas transmission pipelines, the target first transformation algorithm is determined by searching the transformation database, and then the standard gas flow is determined through the target first transformation algorithm using the gas volumetric flow, which may more quickly and accurately meter the gas flow, saving manpower and material resources.

FIG. 4 is a flowchart of another exemplary process for generating standard gas flows at a plurality of sampling time points according to some embodiments of the present disclosure. As shown in FIG. 4, process 400 includes the following operations. In some embodiments, the process 400 may be performed by the gas company management platform in the IoT system for smart gas flow monitoring. Merely by way of example, the process 400 may be performed by the processor in the company server where the gas company management platform is located.

In 410, a transformation model is generated based on historical metering data of different gas transmission pipelines, and the transformation model is set in the one or more company servers; the transformation model is a machine learning model.

In 420, the standard gas flows at the plurality of sampling time points are generated through the transformation model based on the upstream and downstream difference information and the gas characteristic variation of the current period, and the gas volumetric flows at the plurality of sampling time points.

The transformation model refers to a combination of programs that learns patterns from a large amount of historical gas transmission data and applies the patterns. For example, the transformation model may be generated based on the historical metering data of the different gas transmission pipelines and used for standard gas flow determination. In some embodiments, the transformation model may be a machine learning model. For example, the transformation model may be a long short-term memory (LSTM) artificial neural network, or the like.

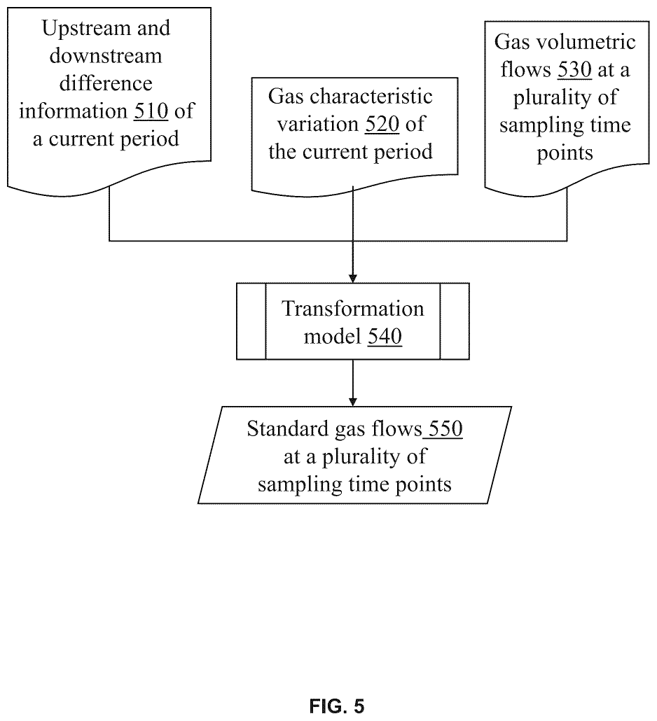

FIG. 5 is a schematic diagram of an exemplary transformation model according to some embodiments of the present disclosure.

In some embodiments, as shown in FIG. 5, inputs of the transformation model 540 may include upstream and downstream difference information 510 of a current period, gas characteristic variation 520 of the current period, and gas volumetric flows 530 at a plurality of sampling time points. An output of the transformation model 540 may be standard gas flows 550 at the plurality of sampling time points.

Parameters of the transformation model 540 may be obtained through training.

In some embodiments, training samples and training labels are determined based on the historical metering data of the different gas transmission pipelines. The training samples are divided into a plurality of different training sets based on the sample upstream and downstream difference information and the sample gas characteristic variations. The transformation model is trained based on the plurality of different training sets.

The training samples include sample upstream and downstream difference information, sample gas volumetric flows, and sample gas characteristic variations. Training labels corresponding to the training samples are actual standard gas flows.

In some embodiments, a training sample for training the transformation model may include sample upstream and downstream difference information, sample gas characteristic variations, and sample gas volumetric flows of a sample period. A training label corresponding to the training sample is actual standard gas flows at a plurality of sample sampling time points of the sample period.

In some embodiments, the training samples and the corresponding training labels may be determined based on historical gas transmission data.

In some embodiments, the processor divides the training samples into a plurality of different training sets based on sample upstream and downstream difference information and sample gas characteristic variations according to preset conditions.

The preset conditions may be set by a technician based on experience. For example, training set 1 may be a set of training samples where the upstream and downstream difference is 0 and the gas characteristic variation is 0. Training set 2 may be a set of training samples where both the upstream and downstream difference and the gas characteristic variation are less than 5%. Training set 3 may be a set of training samples where both the upstream and downstream difference and the gas characteristic variation are between 5% and 15%.

In some embodiments, the processor trains the transformation model based on the plurality of different training sets according to a preset order. The preset order may be set by a technician based on experience.

In some embodiments, the plurality of different training sets have different learning rates. Learning rates corresponding to the different training sets may be set by a technician based on experience. For example, samples with a larger upstream and downstream difference and a larger gas characteristic variation in a training set may correspond to a lower learning rate.

In some embodiments, the processor may obtain a training dataset. The training dataset includes a plurality of sample upstream and downstream difference information, sample gas volumetric flows, sample gas characteristic variations, and training labels corresponding to the training samples. In some embodiments, the processor may perform a plurality of rounds of iterations. At least one round of iteration includes: selecting a training sample from a training set, inputting the training sample into the transformation model, and obtaining a model prediction output corresponding to the training sample. In some embodiments, a value of a loss function is calculated by substituting the model prediction output corresponding to the training sample and a label of the training sample into a formula of a predefined loss function. Model parameters in the transformation model are updated in reverse based on the value of the loss function. In some embodiments, a plurality of ways may be used to update the model parameters in the transformation model. For example, the model parameters in the transformation model may be updated based on a gradient descent manner. When an iteration termination condition is met, the iteration is terminated, and a trained transformation model is obtained. The iteration termination condition may be the convergence of the loss function, a count of iterations reaching a threshold, etc.

In some embodiments, the processor may further obtain new samples and new labels corresponding to a newly installed gas metering device or a modified gas pipeline based on the newly installed gas metering device or the modified gas pipeline, and update the transformation model, thereby effectively improving applicability of the model.

In some embodiments of the present disclosure, dividing the training samples to obtain the plurality of different training sets and training the transformation model based on the plurality of different training sets can significantly improve accuracy and reliability of the model.

In 430, a sampling instruction is generated and sent to a sampling device deployed around the gas metering device, so as to obtain gas sampling data around the gas metering device.

The sampling instruction refers to a related instruction for obtaining sample gas in a gas pipeline. In some embodiments, the processor may generate the sampling instruction based on the standard gas flows at the plurality of sampling time points determined previously.

The sampling device refers to an auxiliary facility installed on the gas pipeline for temporarily sampling gas in the gas pipeline. For example, the sampling device may be installed in a gas valve on the gas pipeline.

The gas sampling data refers to related data of sample gas obtained from the gas pipeline. The gas sampling data includes a gas sampling flow.

In some embodiments, the processor may obtain the gas sampling data through the sampling device.

In some embodiments of the present disclosure, generating the sampling instruction to obtain the gas sampling data when generating the standard gas flows using the transformation model can effectively shorten a time interval between obtaining the gas sampling data and generating the standard gas flows, improve reliability of obtaining the gas sampling data and generating the standard gas flows, and increase accuracy of the transformation model.

In some embodiments of the present disclosure, generating the transformation model based on historical metering data of different gas transmission pipelines and using the trained transformation model can quickly process a large amount of gas metering data, accurately generate standard gas flows at the plurality of sampling time points, and provide good applicability.

In some embodiments, a transformation confidence of the transformation model is determined based on the gas sampling flow and a recent standard gas flow output by the transformation model. An activation frequency of the transformation model is determined based on the transformation confidence.

The gas sampling flow refers to a related flow of sample gas in the gas pipeline. In some embodiments, the processor may collect and obtain the gas sampling flow near the gas metering device through the sampling device. The sampling time corresponding to the gas sampling flow is recorded as a sampling node. For example, an actual standard gas flow determined through sampling by the sampling device may be 2.3 m³/h.

The transformation confidence is a numerical value reflecting an accuracy degree of an output result of the transformation model. In some embodiments, the transformation confidence may be represented by a numerical value between 0 and 1. A larger numerical value indicates a higher transformation confidence.

In some embodiments, the processor determines a transformation confidence of the transformation model corresponding to a nearest sampling time point through a formula based on the gas sampling flow at the sampling node and the standard gas flow at the nearest sampling time point output by the transformation model. The nearest sampling time point is a sampling time point closest to the sampling node. Merely by way of example, the transformation confidence may be calculated and determined by formula (2).

$$transformation confidence corresponding to the nearest sampling time point = 1 - \frac{\vert gas sampling flow at the sampling node - standard gas glow at the nearest sampling time point \vert}{gas sampling flow at the sampling node} . \qquad ( 2 )$$

Descriptions of the gas sampling flow and the standard gas flow output by the transformation model may be found in the above descriptions.

In some embodiments, the processor determines the activation frequency of the transformation model by formula (3) based on the transformation confidence.

$$activation frequency of the transformation model = baseline actvation frequency \times transformation confidence . \qquad ( 3 )$$

The baseline activation frequency refers to a standard frequency for activating the transformation model. In some embodiments, the baseline activation frequency may be determined based on the sampling time point. Related descriptions of the sampling time point may be found in FIG. 2 and related descriptions thereof.

In some embodiments, the activation frequency of the transformation model may also be adjusted according to user requirements.

In some embodiments of the present disclosure, differences between different gas transmission pipelines are significant, and an environment where the gas transmission pipelines are located is complex. The transformation model does not always operate reliably. When the output result of the transformation model is inaccurate, the activation frequency of the transformation model is reduced. Therefore, the transformation confidence of the transformation model is obtained based on the gas sampling flow and the recent standard gas flow output by the transformation model to determine the activation frequency of the transformation model, which can reduce the data processing burden on the gas company management platform.

In some embodiments, the processor may obtain assembly data of the gas transmission pipeline and the gas metering device. In some embodiments, the processor may determine an activation state of the transformation model based on the assembly data and the transformation confidence.

The assembly data refers to data related to installation, use, and maintenance of the gas transmission pipeline, supporting auxiliary facilities, and the gas metering device. For example, the supporting auxiliary facilities may include a sensor, the gas metering device, or the like. The assembly data may include a first installation time and a last repair/maintenance time of the gas transmission pipeline, the supporting auxiliary facilities, and the gas metering device.

In some embodiments, the gas company management platform may obtain the assembly data of the gas transmission pipeline and the supporting auxiliary facilities based on an online database.

The activation state of the transformation model refers to the relevant state of whether the transformation model is used or not.

In some embodiments, the processor may determine the activation state of the transformation model based on a preset time interval and an average transformation confidence within a preset time period through the assembly data of the gas transmission pipeline and the gas metering device. The average transformation confidence is an average value of transformation confidences corresponding to a plurality of nearest sampling time points within the preset time period. For example, the transformation model is not activated in response to a determination that an interval between a last maintenance time of the gas transmission pipeline, the supporting auxiliary facilities, and the gas metering device and a current time is less than the preset time interval, and the average transformation confidence within the preset time period is lower than a preset transformation confidence threshold. The preset time interval may be preset based on the processor. For example, the preset time interval may be one week. The transformation confidence threshold may be preset by a technician.

In some embodiments, the preset time period may be determined based on the first installation time, the last repair/maintenance time, and the current time. For example, a smaller time interval among a time interval between the first installation time and the current time, and a time interval between the last repair/maintenance time and the current time may be taken as a reference time period. The ratio of the reference time period to a count of sampling time points per unit time may be taken as the preset time period. Related descriptions of the sampling time point may be found in FIG. 2 and related descriptions thereof.

In some embodiments of the present disclosure, by obtaining the assembly data of the gas transmission pipeline and the gas metering device and the transformation confidence to determine the activation state of the transformation model, the reliability of gas metering can be improved. By the above method, for a newly installed pipeline or a newly renovated pipeline and auxiliary facilities, the transformation model may be appropriately selected not to be activated because the newly installed pipeline or the newly renovated pipeline and auxiliary facilities may be inaccurate.

It should be noted that the above descriptions of process 200, process 300, and process 400 are merely for example and illustration, and do not limit the scope of application of the present disclosure. For those skilled in the art, various modifications and changes to process 200, process 300, and process 400 may be made under the guidance of the present disclosure. However, these modifications and changes are still within the scope of the present disclosure.

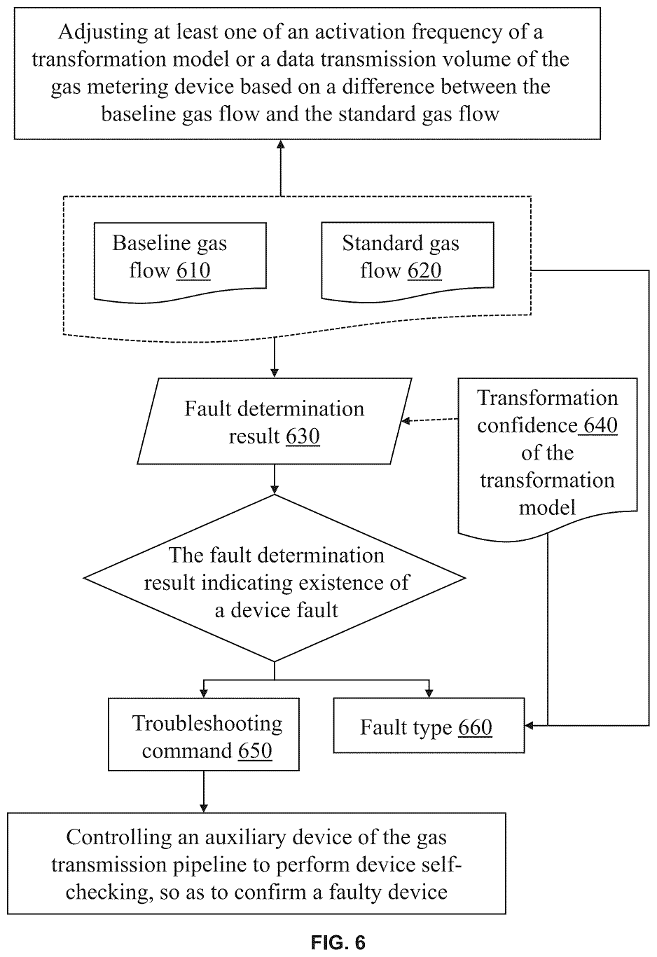

FIG. 6 is an exemplary schematic diagram for determining a faulty device according to some embodiments of the present disclosure.

In some embodiments, the gas company management platform may further generate a fault determination result 630 for a gas transmission pipeline where a gas metering device is deployed based on a baseline gas flow 610 and a standard gas flow 620 corresponding to the gas metering device. It is known that there are two situations: the fault determination result 630 indicating an existence of a device fault, and the fault determination result 630 indicating an non-existence of a device fault. In response to the fault determination result 630 indicating the existence of the device fault, the gas company management platform issues a troubleshooting instruction 650 to control an auxiliary device of the gas transmission pipeline to perform a device self-check, so as to confirm the faulty device.

The fault determination result 630 refers to a result of determining whether the auxiliary device of the gas transmission pipeline has a fault. In some embodiments, the fault determination result 630 may include a determination result of whether a pressure regulating parameter of a gas pressure regulating device is set incorrectly, whether a cold energy recovery and utilization device of the gas pipeline stops operating, or the like.

In some embodiments, the gas company management platform may determine an absolute value of a difference of the gas metering device by calculating an absolute value of a difference between the baseline gas flow 610 and the standard gas flow 620 corresponding to the gas metering device. The gas company management platform may determine whether the absolute value of the difference is greater than a first difference threshold preset by a system (the first difference threshold may be obtained by manual preset) to determine whether the gas transmission pipeline where the gas metering device is located has a device fault. A fault is determined when the absolute value of the difference is greater than the first difference threshold.

The baseline gas flow 610 refers to a gas volumetric flow under a standard condition obtained by the gas company management platform based on a gas density measured by sampling and analyzing gas flowing in real time at a gas gate station and/or a pressure regulating station. In some embodiments, the gas company management platform may query a second preset table based on a gas pressure in sensor data to obtain a gas density corresponding to the gas pressure. The second preset table refers to a table including a correspondence relationship between the gas pressure and the gas density. In some embodiments, the second preset table may be constructed based on actual gas densities collected and recorded under different gas pressures.

In some embodiments, the gas company management platform may obtain the baseline gas flow by a second transformation algorithm based on the gas density and the gas volumetric flow. The second transformation algorithm may be expressed as formula (4):

$$baseline gas flow = e \times \frac{gas density}{standard gas density} * gas volumetric flow . \qquad ( 4 )$$

e is a weight coefficient. The standard gas density refers to a gas density collected under a standard condition (e.g., standard atmospheric pressure, 25° C.).

In some embodiments, the weight coefficient e may be obtained by querying a third preset table based on an average gas impurity content and the gas density of the gas. The average gas impurity content may be obtained based on the gas transmission information. For example, the gas company management platform may obtain gas impurity content data of the plurality of time points collected within the current period from the gas transmission information. The gas company management platform may determine the average gas impurity content by arithmetic averaging or weighted averaging calculation based on the gas impurity content data of the plurality of time points.

In some embodiments, the third preset table refers to a table including a correspondence relationship between the gas impurity content data and the weight coefficient e. In some embodiments, the third preset table may be constructed based on actual weight coefficients e recorded under different gas impurity content data. Merely by way of example, the gas densities, the gas volumetric flows under different conditions, and the standard gas densities and the baseline gas flows under standard conditions of gas with different gas impurity content data may be recorded. Different weight coefficients e may be reversely solved by formula (4) based on the data (the gas densities, the gas volumetric flows, the standard gas densities and the baseline gas flows), and the solved different weight coefficients e are determined as the weight coefficient e corresponding to different gas impurity contents to construct the third preset table.

More descriptions of the gas volumetric flow and the gas transmission information may be found in FIG. 2 and related description thereof.

The troubleshooting instruction 650 refers to a control instruction issued by the gas company management platform in response to a determination that the device fault occurs. The troubleshooting instruction 650 is configured to trigger self-check operation of the auxiliary device of the gas transmission pipeline to confirm a specific faulty device. Merely by way of example, in response to a determination that a fault determination result of a gas transmission pipeline where a gas metering device is located indicates an existence of the device fault, the gas company management platform may issue the troubleshooting instruction 650. The troubleshooting instruction 650 may require all auxiliary devices (e.g., a pressure regulator, a valve, or the like) on the gas transmission pipeline to perform the self-check operation to determine which specific device has a problem.

The auxiliary device of the gas transmission pipeline refers to various hardware devices installed on the gas transmission pipeline for monitoring, regulating, and protecting the gas flow. In some embodiments, the auxiliary device of the gas transmission pipeline may include a pressure regulator, a gas temperature control device, and a cold energy recovery and utilization device, or the like.

In some embodiments, the gas company management platform may send the troubleshooting instruction 650 to the gas equipment object platform to instruct the gas equipment object platform to start a self-check program of the auxiliary device of the gas pipeline where the device fault exists. Merely by way of example, the gas equipment object platform may start a self-check program of the pressure regulator to detect whether a pressure regulation parameter of the pressure regulator is correct.

In some embodiments, in response to a determination that a fault determination result of a gas transmission pipeline where a current gas metering device is located indicates the existence of a device fault, the gas company management platform may determine that the auxiliary device corresponding to the gas transmission pipeline may be the faulty device.

In some embodiments of the present disclosure, the gas company management platform effectively determines whether an auxiliary facility of a related gas transmission pipeline has a device fault based on a difference between a baseline gas flow and a standard gas flow. Accordingly, the gas company management platform performs targeted fault self-check and troubleshooting to improve gas transmission reliability.

In some embodiments, the gas company management platform may generate a fault determination result 630 based on a baseline gas flow 610, a standard gas flow 620, and a transformation confidence 640 of a transformation model. In response to the fault determination result 630 indicating the existence of a faulty device, the gas company management platform may determine a fault type 660 of the faulty device based on the baseline gas flow 610, the standard gas flow 620, and the transformation confidence 640.

In some embodiments, the gas company management platform may multiply the absolute value of the difference of the gas metering device by the transformation confidence 640 of the transformation model to obtain a product result. The gas company management platform may determine that the gas transmission pipeline where the gas metering device is located has a device fault in response to a determination that the product result is greater than the first difference threshold.

More descriptions of the baseline gas flow and the standard gas flow may be found in FIG. 2 and related description thereof. More descriptions of the first difference threshold and the absolute value of the difference of the gas metering device may be found in the foregoing content. More descriptions of the transformation confidence of the transformation model may be found in FIG. 4 and related description thereof.

The fault type 660 refers to a type of each category in a classification result obtained by classifying the device fault according to a specific abnormal situation.

In some embodiments, the gas company management platform may query a fault table based on the absolute value of the difference of the gas metering device to determine the fault type 660.

In some embodiments, the fault table includes a data combination and a fault type corresponding to the data combination (a fault type corresponding to a set of data combination may be one or more). In some embodiments, the data combination includes the absolute value of the difference, the transformation confidence 640, a pipeline number of the gas transmission pipeline and a device number of the gas metering device (the number reflects a location and a type), and a fault troubleshooting time.

In some embodiments, the gas company management platform extracts all situations where a device fault has occurred from historical gas transmission data. The gas company management platform records the baseline gas flow 610, the standard gas flow 620, the transformation confidence 640, the pipeline number of the gas transmission pipeline, the device number of the gas metering device, and a fault troubleshooting time for each fault to construct a data combination. The gas company management platform classifies fault data according to different fault types. The gas company management platform stores a classification result and a corresponding data combination in a database or a table to construct the fault table. The transformation confidence recorded for each fault may be set as an occurrence probability of a fault type corresponding to the fault.

In some embodiments of the present disclosure, the gas company management platform considers using the transformation confidence of the transformation model for device fault determination. Such an approach can improve determination accuracy, reduce influence and interference caused by an error output by the transformation model, avoid misjudgment. Reasonably determining a fault type can clarify a focus of fault self-check and avoid delaying fault repair time.

In some embodiments, the gas company management platform may adjust at least one of an activation frequency of the transformation model and/or a data transmission volume of the gas metering device based on the difference between the baseline gas flow 610 and the standard gas flow 620.

The difference refers to an absolute value of the difference between the baseline gas flow 610 and the standard gas flow 620 corresponding to the gas metering device.

The data transmission volume of the gas metering device refers to a data amount of data transmitted from the gas metering device to the gas equipment object platform via a network per unit time. In some embodiments, the gas company management platform may determine the data transmission volume by recording a data amount of data transmitted per unit time.

In some embodiments, the gas company management platform may set a rule that a larger difference between the baseline gas flow 610 and the standard gas flow 620 corresponding to the gas metering device leads to a lower activation frequency of the transformation model. In some embodiments, the gas company management platform may determine an adjusted data transmission volume of the gas metering device based on the data transmission volume of the gas metering device before adjustment and the difference between the baseline gas flow 610 and the standard gas flow 620 corresponding to the gas metering device. The gas company management platform may instruct the gas equipment object platform to adjust a collection frequency and/or a data upload frequency of the gas metering device according to the adjusted data transmission volume to adjust the data transmission volume of the gas metering device. Merely by way of example, the gas company management platform determines the adjusted data transmission volume of the gas metering device according to the following formula:

$${a}_{1} = {a}_{0} \times ( 1 - b / c ) ,$$

where a₁ is the adjusted data transmission volume, a₀ is the data transmission volume before adjustment, b is the absolute value of the difference between the baseline gas flow 610 and the standard gas flow 620 corresponding to the gas metering device, and c is the baseline gas flow 610 corresponding to the gas metering device.

In some embodiments of the present disclosure, the gas company management platform may consider the standard gas flow to adjust the activation frequency of the transformation model and/or the data transmission volume of the gas metering device. Reducing the activation frequency of the transformation model can reduce an unnecessary computational burden and avoid system resource waste. Adjusting the data transmission volume of the gas metering device can reduce network load while ensuring transmission of key data, thereby improving response speed and stability of a system.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be noted that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the disclosure disclosed herein are illustrative of the principles of the embodiments of the disclosure. Other modifications that may be employed may be within the scope of the disclosure. Thus, by way of example, but not of limitation, alternative configurations of the embodiments of the disclosure may be utilized in accordance with the teachings herein. Accordingly, embodiments of the present disclosure are not limited to that precisely as shown and described.

What is claimed is:

1. A method for smart gas flow monitoring based on Internet of Things (IoT), wherein the method is implemented based on an IoT system for smart gas flow monitoring, the IoT system including a gas user platform, a gas service platform, a gas company management platform, a gas company sensor network platform, and a gas equipment object platform;
the gas company management platform is configured on one or more company servers;
the method is executed by the gas company management platform, and the method comprises:
generating gas transmission information with a time label based on sensor data uploaded by a pipeline sensor and historical sampling data uploaded by at least one of a gas gate station or a pressure regulating station, and storing the gas transmission information in the one or more company servers;
obtaining gas volumetric flows collected by a gas metering device deployed on a gas transmission pipeline at a plurality of time points within a current period;
generating standard gas flows of the gas transmission pipeline at the plurality of time points within the current period through data preprocessing based on the gas volumetric flows;
generating a cumulative gas flow of the gas transmission pipeline within the current period based on the standard gas flows; and
controlling at least one of an opening/closing state or an opening degree of a regulating valve of the gas transmission pipeline based on the cumulative gas flow, to determine a gas flow entering a gas generation device.

2. The method according to claim 1, wherein the generating standard gas flows of the gas transmission pipeline at the plurality of time points within the current period through data preprocessing based on the gas volumetric flows includes:
obtaining upstream and downstream difference information of the gas transmission pipeline within the current period based on the gas equipment object platform;
generating a gas characteristic variation of the gas transmission pipeline within the current period based on the gas transmission information at a plurality of sampling time points within the current period;
generating the standard gas flows at the plurality of sampling time points based on the upstream and downstream difference information and the gas characteristic variation of the current period, and the gas volumetric flows at the plurality of sampling time points;
determining the standard gas flows at the plurality of time points based on the standard gas flows at the plurality of sampling time points; and
adjusting a sampling time point interval of the gas transmission pipeline based on the standard gas flows at the plurality of sampling time points.

3. The method according to claim 2, wherein the generating the standard gas flows at the plurality of sampling time points based on the upstream and downstream difference information and the gas characteristic variation of the current period, and the gas volumetric flows at the plurality of sampling time points includes:
generating a transformation database based on historical metering data of different gas transmission pipelines, and setting the transformation database in the one or more company servers; wherein the transformation database includes a plurality of sets of upstream and downstream difference information, gas transmission information, and gas characteristic variations, and a plurality of corresponding first transformation algorithms;
determining a target first transformation algorithm by searching the transformation database based on the upstream and downstream difference information, the gas characteristic variation, and the gas transmission information of the current period; and
generating the standard gas flows based on the gas volumetric flows through the target first transformation algorithm.

4. The method according to claim 3, wherein the generating the standard gas flows based on the gas volumetric flows through the target first transformation algorithm includes:
in response to the upstream and downstream difference information and the gas characteristic variation satisfying a preset stable condition, generating the standard gas flows based on the gas volumetric flows through the target first transformation algorithm.

5. The method according to claim 2, wherein the generating the standard gas flows at the plurality of sampling time points based on the upstream and downstream difference information and the gas characteristic variation of the current period, and the gas volumetric flows at the plurality of sampling time points includes:
generating a transformation model based on historical metering data of different gas transmission pipelines, and setting the transformation model in the one or more company servers; wherein the transformation model is a machine learning model;
generating the standard gas flows at the plurality of sampling time points through the transformation model based on the upstream and downstream difference information and the gas characteristic variation of the current period, and the gas volumetric flows at the plurality of sampling time points; and
generating a sampling instruction and sending the sampling instruction to a sampling device deployed around the gas metering device, to obtain gas sampling data around the gas metering device.

6. The method according to claim 5, wherein the generating a transformation model based on historical metering data of different gas transmission pipelines includes:
determining training samples and training labels based on the historical metering data of the different gas transmission pipelines; wherein the training samples include sample upstream and downstream difference information, sample gas volumetric flows, and sample gas characteristic variations of sample pipelines, and the training labels corresponding to the training samples are actual standard gas flows;
dividing the training samples into a plurality of different training sets based on the sample upstream and downstream difference information and the sample gas characteristic variations; and
training the transformation model based on the plurality of different training sets; wherein the plurality of different training sets have different learning rates.

7. The method according to claim 5, wherein the gas sampling data includes a gas sampling flow, and the method further comprises:
determining a transformation confidence of the transformation model based on the gas sampling flow and a recent standard gas flow output by the transformation model; and
determining an activation frequency of the transformation model based on the transformation confidence.

8. The method according to claim 7, further comprising:
obtaining assembly data of the gas transmission pipeline and the gas metering device; and
determining an activation state of the transformation model based on the assembly data and the transformation confidence.

9. The method according to claim 1, further comprising:
generating a fault determination result for the gas transmission pipeline where the gas metering device is deployed based on a baseline gas flow and the standard gas flow corresponding to the gas metering device; and
in response to the fault determination result indicating an existence of a device fault, issuing a troubleshooting instruction to control an auxiliary device of the gas transmission pipeline to perform device self-checking, so as to confirm a faulty device.

10. The method according to claim 9, further comprising:
generating the fault determination result based on the baseline gas flow, the standard gas flow, and a transformation confidence of a transformation model; and
in response to the fault determination result indicating an existence of the device fault, determining a fault type of the faulty device based on the baseline gas flow, the standard gas flow, and the transformation confidence.

11. The method according to claim 9, further comprising:
adjusting at least one of an activation frequency of a transformation model or a data transmission volume of the gas metering device based on a difference between the baseline gas flow and the standard gas flow.

12. An Internet of Things (IoT) system for smart gas flow monitoring, comprising: a gas user platform, a gas service platform, a gas company management platform, a gas company sensor network platform, and a gas equipment object platform;
wherein the gas company management platform is configured on one or more company servers;
wherein the gas company management platform is configured to:
generate gas transmission information with a time label based on sensor data uploaded by a pipeline sensor and historical sampling data uploaded by at least one of a gas gate station or a pressure regulating station, and store the gas transmission information in the one or more company servers;
obtain gas volumetric flows collected by a gas metering device deployed on a gas transmission pipeline at a plurality of time points within a current period;
generate standard gas flows of the gas transmission pipeline at the plurality of time points within the current period through data preprocessing based on the gas volumetric flows;
generate a cumulative gas flow of the gas transmission pipeline within the current period based on the standard gas flows; and
control at least one of an opening/closing state or an opening degree of a regulating valve of the gas transmission pipeline based on the cumulative gas flow, to determine a gas flow entering a gas generation device.

13. The IoT system according to claim 12, wherein the gas company management platform is further configured to:
obtain upstream and downstream difference information of the gas transmission pipeline within the current period based on the gas equipment object platform;
generate a gas characteristic variation of the gas transmission pipeline within the current period based on the gas transmission information at a plurality of sampling time points within the current period;
generate the standard gas flows at the plurality of sampling time points based on the upstream and downstream difference information and the gas characteristic variation of the current period, and the gas volumetric flows at the plurality of sampling time points;
determine the standard gas flows at the plurality of time points based on the standard gas flows at the plurality of sampling time points; and
adjust a sampling time point interval of the gas transmission pipeline based on the standard gas flows at the plurality of sampling time points.

14. The IoT system according to claim 13, wherein the gas company management platform is further configured to:
generate a transformation database based on historical metering data of different gas transmission pipelines, and setting the transformation database in the one or more company servers; wherein the transformation database includes a plurality of sets of upstream and downstream difference information, gas transmission information, and gas characteristic variations, and a plurality of corresponding first transformation algorithms;
determine a target first transformation algorithm by searching the transformation database based on the upstream and downstream difference information, the gas characteristic variation, and the gas transmission information of the current period; and
generate the standard gas flows based on the gas volumetric flows through the target first transformation algorithm.

15. The IoT system according to claim 13, wherein the gas company management platform is further configured to:
generate a transformation model based on historical metering data of different gas transmission pipelines, and setting the transformation model in the one or more company servers; wherein the transformation model is a machine learning model;
generating the standard gas flows at the plurality of sampling time points through the transformation model based on the upstream and downstream difference information and the gas characteristic variation of the current period, and the gas volumetric flows at the plurality of sampling time points; and
generate a sampling instruction and sending the sampling instruction to a sampling device deployed around the gas metering device, so as to obtain gas sampling data around the gas metering device.

16. The IoT system according to claim 15, wherein the gas company management platform is further configured to:
determine training samples and training labels based on the historical metering data of the different gas transmission pipelines; wherein the training samples include sample upstream and downstream difference information, sample gas volumetric flows, and sample gas characteristic variations of sample pipelines, and the training labels corresponding to the training samples are actual standard gas flows;
divide the training samples into a plurality of different training sets based on the sample upstream and downstream difference information and the sample gas characteristic variations; and
train the transformation model based on the plurality of different training sets; wherein the plurality of different training sets have different learning rates.

17. The IoT system according to claim 15, wherein the gas sampling data includes a gas sampling flow, and the gas company management platform is further configured to:
determine a transformation confidence of the transformation model based on the gas sampling flow and a recent standard gas flow output by the transformation model;
determine an activation frequency of the transformation model based on the transformation confidence.

18. The IoT system according to claim 17, wherein the gas company management platform is further configured to:
obtain assembly data of the gas transmission pipeline and the gas metering device; and
determine an activation state of the transformation model based on the assembly data and the transformation confidence.

19. The IoT system according to claim 12, wherein the gas company management platform is further configured to:
generate a fault determination result for the gas transmission pipeline where the gas metering device is deployed based on a baseline gas flow and the standard gas flow corresponding to the gas metering device; and
in response to the fault determination result indicating an existence of a device fault, issuing a troubleshooting instruction to control an auxiliary device of the gas transmission pipeline to perform device self-checking, so as to confirm a faulty device.

20. A non-transitory computer-readable storage medium, wherein the storage medium stores computer instructions, and when a computer reads the computer instructions in the storage medium, the computer executes the following operations:
generating gas transmission information with a time label based on sensor data uploaded by a pipeline sensor and historical sampling data uploaded by at least one of a gas gate station or a pressure regulating station, and storing the gas transmission information in the one or more company servers;
obtaining gas volumetric flows collected by a gas metering device deployed on a gas transmission pipeline at a plurality of time points within a current period;
generating standard gas flows of the gas transmission pipeline at the plurality of time points within the current period through data preprocessing based on the gas volumetric flows;
generating a cumulative gas flow of the gas transmission pipeline within the current period based on the standard gas flows; and
controlling at least one of an opening/closing state or an opening degree of a regulating valve of the gas transmission pipeline based on the cumulative gas flow, to determine a gas flow entering a gas generation device.
